(19) United States
(12) Patent Application Publication
(10) Pub. No.: US 2022/0063566 A1
(43) Pub. Date: Mar. 3, 2022

(54) SENSOR SYSTEM WITH CLEANING

(71) Applicant: Ford Global Technologies, LLC, Dearborn, MI (US)

(72) Inventors: Ashwin Arunmozhi, Canton, MI (US); Venkatesh Krishnan, Canton, MI (US); Michael Robertson, JR., Garden City, MI (US); Segundo Baldovino, Novi, MI (US); Tony Misovski, Oxford, MI (US); Kunal Singh, Farmington Hills, MI (US)

(73) Assignee: Ford Global Technologies, LLC, Dearborn, MI (US)

(21) Appl. No.: 17/009,007

(22) Filed: Sep. 1, 2020

(51) Int. Cl. B60S 1/52; F04B 11/00; B60S 1/54

(52) U.S. Cl. CPC B60S 1/52; B60S 1/54; F04B 11/00

(57) ABSTRACT

A sensor system includes a sensor including a sensor window, a pump, a liquid nozzle aimed at the sensor window, a valve positioned and operable to control fluid flow from the pump to the liquid nozzle, and a computer communicatively coupled to the valve. The computer is programmed to, in response to detecting an obstruction on the sensor window, continuously activate the pump for a first time period; and during the first time period, operate the valve according to a preset sequence. The preset sequence includes opening and then closing the valve at least twice during the first time period.

### BACKGROUND

Autonomous vehicles typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. When sensor lenses, covers, and the like become dirty, smudged, etc., sensor operation can be impaired or precluded.

### BRIEF DESCRIPTION OF THE DRAWINGS

FIG. 1 is a perspective view of an example vehicle including a sensor system.

FIG. 2 is a diagram of a first example of a cleaning system of the sensor system.

FIG. 3 is a diagram of a second example of the cleaning system of the sensor system.

FIG. 4 is a diagram of a third example of the cleaning system of the sensor system.

FIG. 5 is a diagram of a fourth example of the cleaning system of the sensor system.

FIG. 6 is a block diagram of a control system of the sensor system.

FIG. 7 is a process flow diagram of an example process for controlling the cleaning system.

FIG. 8A is a plot of a first preset sequence for the cleaning system.

FIG. 8B is a plot of a second preset sequence for the cleaning system.

FIG. 8C is a plot of a third preset sequence for the cleaning system.

### DETAILED DESCRIPTION

A sensor system includes a sensor including a sensor window, a pump, a liquid nozzle aimed at the sensor window, a valve positioned and operable to control fluid flow from the pump to the liquid nozzle, and a computer communicatively coupled to the valve. The computer is programmed to, in response to detecting an obstruction on the sensor window, continuously activate the pump for a first time period; and during the first time period, operate the valve according to a preset sequence. The preset sequence includes opening and then closing the valve at least twice during the first time period.

The sensor may be communicatively coupled to the computer, the preset sequence may be a first preset sequence, and the computer may be further programmed to identify a type of the obstruction on the sensor window based on data received from the sensor; select the first preset sequence from a plurality of preset sequences in response to identifying the type of the obstruction as a first type; and during the first time period, operate the valve according to the selected preset sequence. The plurality of preset sequences may include a second preset sequence, and the computer may be further programmed to select the second preset sequence in response to identifying the type of the obstruction as a second type. The second preset sequence may include opening and then closing the valve once during the first time period.

The sensor system may further include an air nozzle aimed at the sensor window and a pressure source operable to supply gas to the air nozzle and communicatively coupled to the computer, and the computer may be further programmed to continuously activate the pressure source for the first time period.

The valve may be a solenoid valve.

The valve may be a first valve, the sensor system may further include a reservoir and a second valve, the pump may be positioned to pump fluid from the reservoir to the first valve, and the second valve may be positioned and operable to control fluid flow from the first valve to the reservoir. The second valve may be communicatively coupled to the computer, and the computer may be further programmed to open the second valve when the first valve is closed and to close the second valve when the first valve is open.

The sensor system may further include a shock-absorbing unit fluidly coupled to the valve and to the liquid nozzle, and the shock-absorbing unit may include a fluid chamber having a variable internal volume and a spring biasing the fluid chamber to a first internal volume.

The valve may be a first valve, the sensor system may further include a reservoir, a junction, and a second valve, the pump may be positioned to pump fluid from the reservoir to the junction, the junction may split fluid from the reservoir between the first valve and the second valve, and the second valve may be positioned and operable to control fluid flow from the junction to the reservoir. The sensor system may further include a casing containing the junction, the first valve, and the second valve, and the casing may be spaced from the pump and from the liquid nozzle.

The second valve may be communicatively coupled to the computer, and the computer may be further programmed to open the second valve when the first valve is closed and to close the second valve when the first valve is open.

A computer includes a processor and a memory storing instructions executable by the processor to, in response to detecting an obstruction on a sensor window of a sensor, continuously activate a pump for a first time period; and during the first time period, operate a valve according to a preset sequence. The valve is positioned and operable to control fluid flow from the pump to a liquid nozzle. The preset sequence includes opening and then closing the valve at least twice during the first time period.

The preset sequence may be a first preset sequence, and the instructions may further include to identify a type of the obstruction on the sensor window of the sensor based on data received from the sensor, select the first preset sequence from a plurality of preset sequences in response to identifying the type of the obstruction as a first type, and during the first time period, operate the valve according to the selected preset sequence. The plurality of preset sequences may include a second preset sequence, and the instructions may further include to select the second preset sequence in response to identifying the type of the obstruction as a second type. The second preset sequence may include opening and then closing the valve once during the first time period.

The instructions may further include to continuously activate a pressure source supplying an air nozzle for the first time period.

The valve may be a first valve, and the instructions may further include to open a second valve when the first valve is closed and to close the second valve when the first valve is open.

A method includes, in response to detecting an obstruction on the sensor window, continuously activating a pump for a first time period; and during the first time period, operating a valve according to a preset sequence. The valve is positioned and operable to control fluid flow from the pump to a liquid nozzle. The preset sequence includes opening and then closing the valve at least twice during the first time period.

With reference to the Figures, a sensor system 32 for a vehicle 30 includes at least one sensor 34 including a sensor window 36, a pump 38, a liquid nozzle 40 aimed at the sensor window 36, a first valve 42 positioned and operable to control fluid flow from the pump 38 to the liquid nozzle 40, and a computer 44 communicatively coupled to the first valve 42. The computer 44 is programmed to, in response to detecting an obstruction on the sensor window 36, continuously activate the pump 38 for a first time period; and during the first time period, operate the first valve 42 according to a preset sequence. The preset sequence includes opening and then closing the first valve 42 at least twice during the first time period.

Because the preset sequence includes closing the first valve 42 at least once in the middle of the first time period, the fluid sprayed by the liquid nozzle 40 has time to soak into an obstruction on the sensor window 36. The sensor system 32 can remove obstructions approximately as effectively as, but while using less fluid than, a system that sprays for the entirety of the first time period. Activating the pump 38 continuously from the beginning to the end of the first time period, rather than turning the pump 38 on and off with the first valve 42 opening and closing, can increase the lifespan of the pump 38 by subjecting the pump 38 to fewer duty cycles. Also, the pump 38 is already active when the first valve 42 is opened for the second time (and possibly subsequent times) during the first time period, meaning that spraying from the liquid nozzle 40 is resumed more quickly than if the pump 38 were deactivated with the first valve 42 closing.

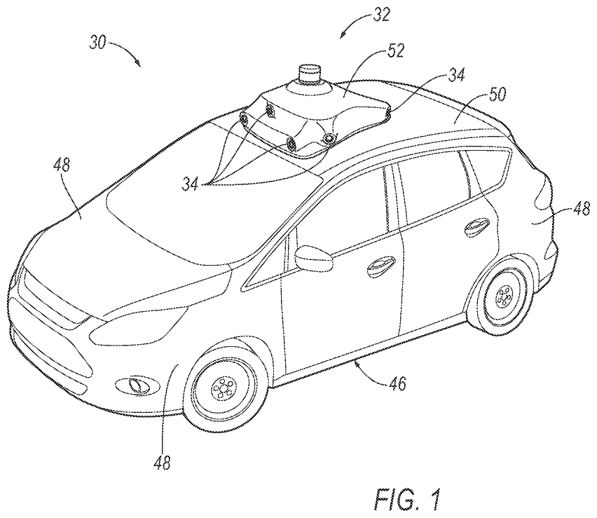

With reference to FIG. 1, the vehicle 30 may be any passenger or commercial automobile such as a car, a truck, a sport utility vehicle, a crossover, a van, a minivan, a taxi, a bus, etc.

The vehicle 30 may be an autonomous vehicle. A vehicle computer can be programmed to operate the vehicle 30 independently of the intervention of a human driver, completely or to a lesser degree. The vehicle computer may be programmed to operate a propulsion, a brake system, a steering system, and/or other vehicle systems. For the purposes of this disclosure, autonomous operation means the vehicle computer controls the propulsion, brake system, and steering system without input from a human driver; semi-autonomous operation means the vehicle computer controls one or two of the propulsion, brake system, and steering system and a human driver controls the remainder; and nonautonomous operation means a human driver controls the propulsion, brake system, and steering system.

The vehicle 30 includes a body 46. The vehicle 30 may be of a unibody construction, in which a frame and the body 46 of the vehicle 30 are a single component. The vehicle 30 may, alternatively, be of a body-on-frame construction, in which the frame supports the body 46 that is a separate component from the frame. The frame and body 46 may be formed of any suitable material, for example, steel, aluminum, etc.

The body 46 includes body panels 48 partially defining an exterior of the vehicle 30. The body panels 48 may present a class-A surface, e.g., a finished surface exposed to view by a customer and free of unaesthetic blemishes and defects. The body panels 48 include, e.g., a roof 50, etc.

The sensor system 32 includes a housing 52 for the sensor 34. The housing 52 is attachable to the vehicle 30, e.g., to one of the body panels 48 of the vehicle 30, e.g., the roof 50. For example, the housing 52 may be shaped to be attachable to the roof 50, e.g., may have a shape matching a contour of the roof 50. The housing 52 may be attached to the roof 50, which can provide the sensor 34 with an unobstructed field of view of an area around the vehicle 30. The housing 52 may be formed of, e.g., plastic or metal. The sensor 34 may be one of a plurality of sensors 34 housed in the housing 52.

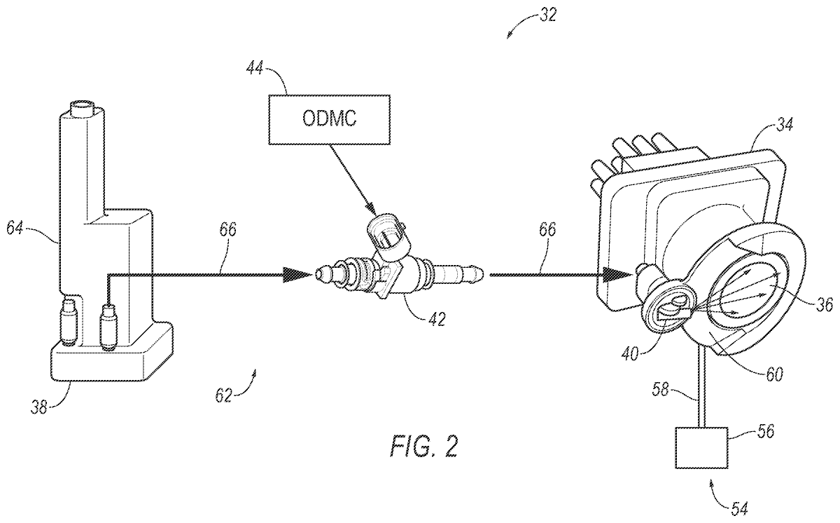

With reference to FIGS. 2-5, an air cleaning system 54 includes a pressure source 56, air supply lines 58, and at least one air nozzle 60. The pressure source 56 and the air nozzle 60 are fluidly connected to each other (i.e., fluid can flow from one to the other) in sequence through the air supply lines 58.

The pressure source 56 can be a compressor, a blower, etc. For example, the pressure source 56 may be any suitable type of compressor, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; or any other suitable type.

The pressure source 56 is operable to supply gas to the air nozzle 60, e.g., via the air supply lines 58. The air supply lines 58 extend from the pressure source 56 to the air nozzles 60. The air supply lines 58 may be, e.g., flexible tubes.

The air nozzle 60 is aimed at the sensor window 36. If the housing 52 contains multiple sensors 34 each having a sensor window 36, then one air nozzle 60 can be provided for each sensor 34 and aimed at the respective sensor window 36.

A liquid cleaning system 62 of the vehicle 30 includes a reservoir 64, the pump 38, liquid supply lines 66, the first valve 42, and the liquid nozzle 40. The reservoir 64, the pump 38, and the liquid nozzle 40 are fluidly connected to each other (i.e., fluid can flow from one to the other). If the housing 52 contains multiple sensors 34, then one first valve 42 and liquid nozzle 40 can be provided for each sensor 34. The liquid cleaning system 62 distributes washer fluid stored in the reservoir 64 to the liquid nozzle 40. “Washer fluid” is any liquid stored in the reservoir 64 for cleaning. The washer fluid may include solvents, detergents, diluents such as water, etc.

The reservoir 64 may be a tank fillable with liquid, e.g., washer fluid for window cleaning. The reservoir 64 may be disposed in the housing 52 or may be disposed in a front of the vehicle 30, specifically, in an engine compartment forward of a passenger cabin. The reservoir 64 may store the washer fluid only for supplying the sensor system 32 or also for other purposes, such as supply to a windshield.

The pump 38 is positioned to pump fluid from the reservoir 64 to the first valve 42. The pump 38 forces the washer fluid through the liquid supply lines 66 to the liquid nozzles 40 with sufficient pressure that the washer fluid sprays from the liquid nozzles 40. The pump 38 is fluidly connected to the reservoir 64. The pump 38 may be attached to or disposed in the reservoir 64.

The liquid supply lines 66 extend from the pump 38 to the first valve 42 and from the first valve 42 to the liquid nozzle 40. The liquid supply lines 66 may be, e.g., flexible tubes.

The first valve 42 is positioned and operable to control fluid flow from the pump 38 to the liquid nozzle 40. Specifically, fluid from the liquid supply line 66 from the pump 38 must flow through the first valve 42 to reach the liquid supply line 66 that provides fluid to the liquid nozzle 40. The first valve 42 controls flow by being actuatable between an open position permitting flow and a closed position blocking flow from the incoming to the outgoing of the liquid supply lines 66. The first valve 42 can be a solenoid valve. As a solenoid valve, the first valve 42 includes a solenoid and a plunger. Electrical current through the solenoid generates a magnetic field, and the plunger moves in response to changes in the magnetic field. Depending on its position, the plunger permits or blocks flow through the first valve 42.

The liquid nozzle 40 is positioned to receive fluid from the first valve 42 via one of the liquid supply lines 66. The liquid nozzle 40 is aimed at the sensor window 36. If the housing 52 contains multiple sensors 34 each having a sensor window 36, one first valve 42 and one corresponding liquid nozzle 40 is provided for each sensor 34.

The sensor 34 detects the external world, e.g., objects and/or characteristics of surroundings of the vehicle 30, such as other vehicles, road lane markings, traffic lights and/or signs, pedestrians, etc. For example, the sensor 34 may be a radar sensor, a scanning laser range finder, a light detection and ranging (LIDAR) device, or an image processing sensor such as a camera.

The sensor 34 includes a sensor window 36. The sensor 34 has a field of view through the sensor window 36. The sensor window 36 is transparent with respect to wavelengths of light detectable by the sensor 34. For example, if the sensor 34 is a camera, the sensor window 36 can be a lens.

With reference to FIG. 2, in a first example of the sensor system 32, the first valve 42 is the only valve in the path of fluid flow from the pump 38 to the liquid nozzle 40. One of the liquid supply lines 66 leads directly from the first valve 42 to the liquid nozzle 40 without branching. When the pump 38 is activated and the first valve 42 is in the open position, fluid flows from the reservoir 64 to the liquid nozzle 40. When the first valve 42 switches to the closed position, fluid ceases to flow from the reservoir 64 to the liquid nozzle 40.

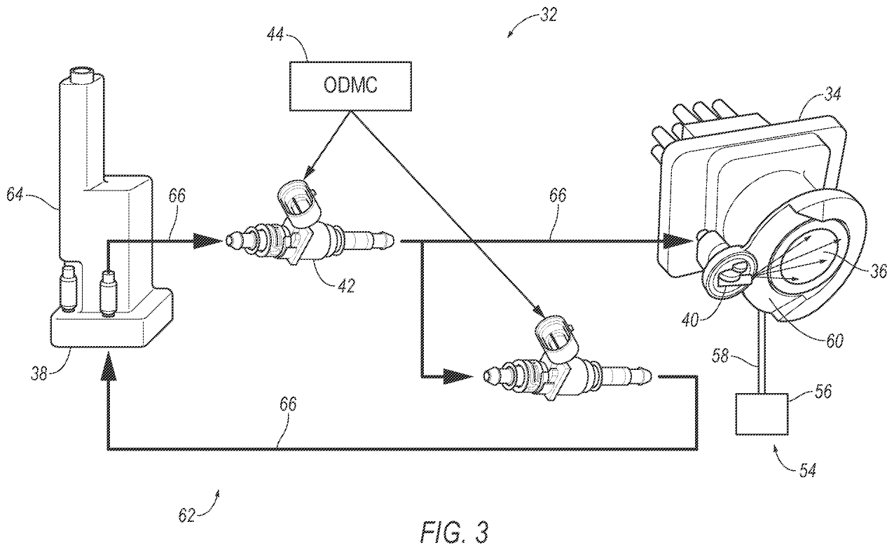

With reference to FIG. 3, in a second example of the sensor system 32, the sensor system 32 includes a second valve 68. The second valve 68 is positioned and operable to control fluid flow from the first valve 42 to the reservoir 64. The second valve 68 can be a solenoid valve as described above for the first valve 42. Liquid supply lines 66 lead from the first valve 42 and split between the liquid nozzle 40 and the second valve 68. One of the liquid supply lines 66 leads from the second valve 68 to the reservoir 64.

As described in more detail below, the second valve 68 is put into the closed position when the first valve 42 is in the open position, and vice versa. When the pump 38 is activated, the first valve 42 is in the open position, and the second valve 68 is in the closed position, fluid flows from the reservoir 64 to the liquid nozzle 40. When the first valve 42 switches to the closed position and the second valve 68 switches to the open position, fluid ceases to flow from the reservoir 64 to the liquid nozzle 40. Also, fluid that is already in the liquid supply line 66 from the first valve 42 to the liquid nozzle 40 experiences a pressure drop because of the second valve 68 being in the open position, meaning that fluid stops flowing out of the liquid nozzle 40 more quickly than in the first example of the sensor system 32. Moreover, the fluid can be recaptured by flowing through the second valve 68 back to the reservoir 64.

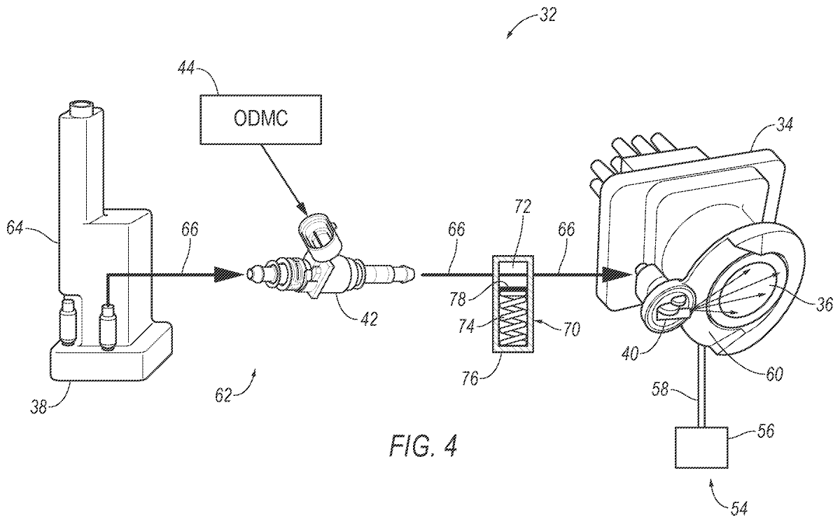

With reference to FIG. 4, in a third example of the sensor system 32, the sensor system 32 includes a shock-absorbing unit 70 fluidly coupled to the first valve 42 and to the liquid nozzle 40. Specifically, one of the liquid supply lines 66 leads from the first valve 42 to the shock-absorbing unit 70, and one of the liquid supply lines 66 leads from the shock-absorbing unit 70 to the liquid nozzle 40.

The shock-absorbing unit 70 includes a fluid chamber 72 having a variable internal volume and a spring 74 biasing the fluid chamber 72 to a first internal volume. For example, the shock-absorbing unit 70 can include a shock-absorbing-unit housing 76 and a panel 78 slidable in the shock-absorbing-unit housing 76. The fluid chamber 72 is formed of the shock-absorbing-unit housing 76 and the panel 78, with the panel 78 sealing the fluid chamber 72 in a portion of the shock-absorbing-unit housing 76. The spring 74 extends from the shock-absorbing-unit housing 76 to the panel 78. The spring 74 biases the panel 78 to a first position; in other words, when the spring 74 is in a relaxed state, the panel 78 is at the first position. When the panel 78 is at the first position, the fluid chamber 72 is at the first internal volume.

When the pump 38 is activated and the first valve 42 is in the open position, fluid flows from the reservoir 64 to the liquid nozzle 40, via the fluid chamber 72. Pressure of the fluid pushes against the panel 78 and compresses the spring 74, and the internal volume of the fluid chamber 72 becomes greater than the first internal volume. When the first valve 42 switches to the closed position, pressure in the liquid supply lines 66 drops, and the spring 74 extends and decreases the volume of the fluid chamber 72 toward the first internal volume. The push from the fluid chamber 72 moves some of the remaining fluid out through the liquid nozzle 40 and more quickly stops the flow through the liquid nozzle 40.

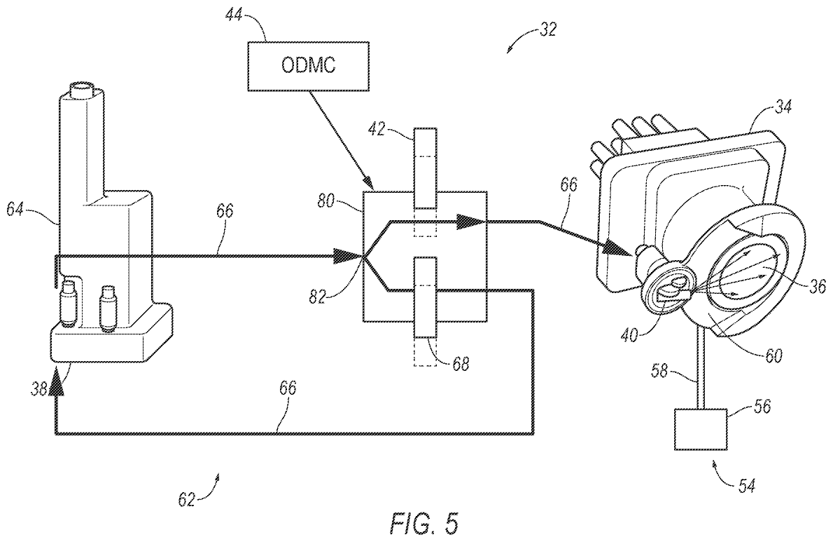

With reference to FIG. 5, in a fourth example of the sensor system 32, the sensor system 32 includes a casing 80 containing a junction 82, the first valve 42, and the second valve 68. The casing 80 is spaced from the pump 38 and from the liquid nozzle 40, e.g., with liquid supply lines 66 from the pump 38 to the casing 80 and from the casing 80 to the liquid nozzle 40. The spacing can help packaging of components in the housing 52. The pump 38 is positioned to pump fluid from the reservoir 64 to the junction 82; e.g., one of the liquid supply lines 66 leads from the pump 38 to the junction 82. The junction 82 splits flow from the reservoir 64 via that liquid supply line 66 between the first valve 42 and the second valve 68. The first valve 42 is positioned and operable to control fluid flow from the junction 82 to the liquid nozzle 40; e.g., one of the liquid supply lines 66 leads from the first valve 42 to the liquid nozzle 40. The second valve 68 is positioned and operable to control fluid flow from the junction 82 to the reservoir 64; e.g., one of the liquid supply lines 66 leads from the second valve 68 to the reservoir 64.

As described in more detail below, the second valve 68 is put into the closed position when the first valve 42 is in the open position, and vice versa. For example, signals may be almost simultaneously sent to the first valve 42 to switch to the open position and the second valve 68 to switch to the closed position, or vice versa. For another example, the plungers of the first valve 42 and the second valve 68 may be fixed together, so the plungers necessarily move together. When one of the plungers is in the open position, the other of the plungers is in the closed position.

When the pump 38 is activated, the first valve 42 is in the open position, and the second valve 68 is in the closed position, fluid flows from the reservoir 64 to the liquid nozzle 40. When the first valve 42 switches to the closed position and the second valve 68 switches to the open position, fluid ceases to flow from the reservoir 64 to the liquid nozzle 40. The second valve 68 being in the open position can provide pressure relief in the liquid supply lines 66 from the pump 38 to the junction 82, particularly if the pump 38 remains activated, as described below. While the pump 38 remains activated, the fluid can be recaptured by flowing through the second valve 68 back to the reservoir 64.

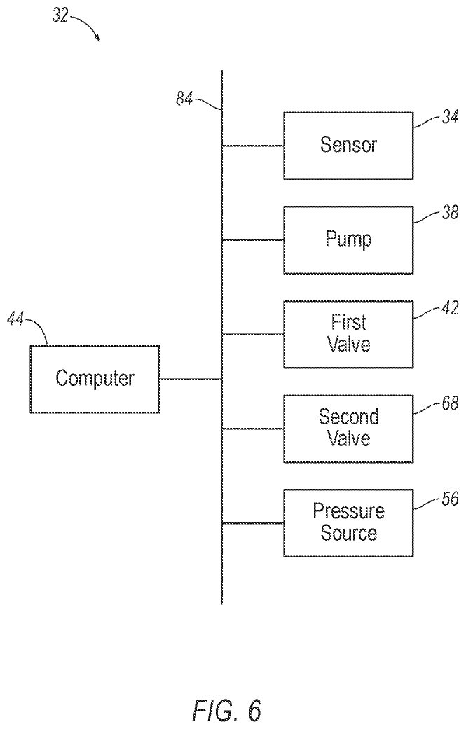

With reference to FIG. 6, a block diagram of the system 32, the computer 44 is a microprocessor-based computing device, e.g., a generic computing device including a processor and a memory, an electronic controller or the like, a field-programmable gate array (FPGA), an application-specific integrated circuit (ASIC), etc. The computer 44 can thus include a processor, a memory, etc. The memory of the computer 44 can include media for storing instructions executable by the processor as well as for electronically storing data and/or databases, and/or the computer 44 can include structures such as the foregoing by which programming is provided. The computer 44 can be multiple computers coupled together.

The computer 44 may transmit and receive data through a communications network 84 such as a controller area network (CAN) bus, Ethernet, WiFi, Local Interconnect Network (LIN), onboard diagnostics connector (OBD-II), and/or by any other wired or wireless communications network. The computer 44 may be communicatively coupled to the sensor 34, the pump 38, the first valve 42, the second valve 68 (if present), the pressure source 56, and other components via the communications network 84.

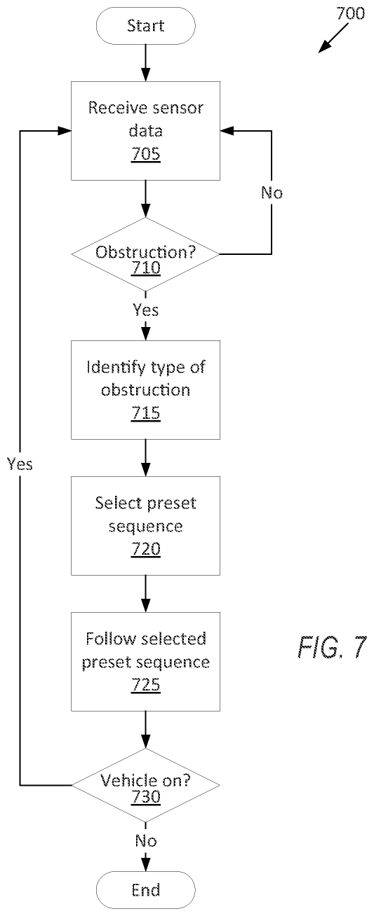

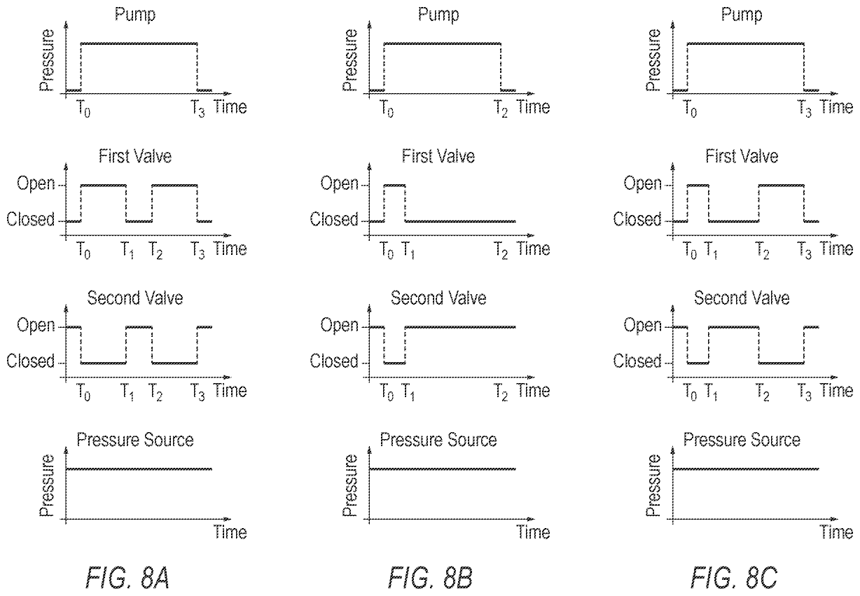

FIG. 7 is a process flow diagram illustrating an exemplary process 700 for controlling the liquid cleaning system 62 of the sensor system 32. The memory of the computer 44 stores executable instructions for performing the steps of the process 700 and/or programming can be implemented in structures such as mentioned above. As a general overview of the process 700, if sensor data from the sensor 34 indicates an obstruction of the field of view of the sensor 34, the computer 44 identifies a type of the obstruction; selects a preset sequence of operations of the pump 38, the first valve 42, and, if present, the second valve 68; and executes the selected preset sequence, all for as long as the vehicle 30 is on. For the purposes of this disclosure, a “preset sequence” is defined as a set of instructions and corresponding times to execute each instruction. FIGS. 8A-C each show one preset sequence, which are described in more detail below with respect to a block 725. If the housing 52 contains multiple sensors 34 each having a sensor window 36, then the process 700 can be run independently for each sensor 34.

The process 700 begins in a block 705, in which the computer 44 receives data from the sensor 34. For example, if the sensor 34 is a camera, the data are a sequence of image frames of the field of view of the sensor 34. Each image frame is a two-dimensional matrix of pixels. Each pixel has a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Position in an image frame, i.e., position in the field of view of the sensor 34 at the time that the image frame was recorded, can be specified in pixel dimensions or coordinates, e.g., an ordered pair of pixel distances, such as a number of pixels from a top edge and a number of pixels from a left edge of the field of view.

Next, in a decision block 710, the computer 44 determines whether an obstruction is on the sensor window 36, typically by identifying an obstruction region (i.e., obstruction region) on the window. For example, the computer 44 can determine, e.g., according to conventional image-analysis techniques, that a set of pixels in image data received from the sensor 34 is unchanging over a preset duration compared to the other of the pixels in the image data, suggesting that a portion of the field of view of the sensor 34 has been covered. The preset duration can be chosen to be sufficiently long that the image data should have changed. The set of pixels can be subject to requirements for pixel area, compactness, etc. Other algorithms may be used, e.g., classical computer vision or machine learning algorithms such as convolutional neural networks. If an obstruction is not detected, the process 700 returns to the block 705 to continue monitoring data from the sensor 34. If an obstruction is detected, the process 700 proceeds to a block 715.

In the block 715, the computer 44 identifies a type of the obstruction on the sensor window 36 based on the data received from the sensor 34 in the block 705. For example, the computer 44 can identify the type of the obstruction applying conventional image-recognition techniques to an obstruction region in an image as identified in the block 710, e.g., a convolutional neural network programmed to accept images as input and output an identified type of obstruction. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type of obstruction, and the final output is the type of obstruction with the highest score. A type of obstruction means a specification or classification of material forming the obstruction; types of obstructions can include, e.g., dust, dirt/mud, crushed insect, snow, etc. Alternatively, the convolutional neural network can be used for both decision block 710 and block 715, with the types of obstructions also including “no obstruction,” and an identification of “no obstruction” leading from the decision block 710 back to the block 705 to continue monitoring data from the sensor 34.

Next, in a block 720, the computer 44 selects a preset sequence from a plurality of preset sequences in response to identifying the type of obstruction as a particular type. If the obstruction is a first type, the computer 44 selects a first preset sequence; if the obstruction is a second type, the computer 44 selects a second preset sequence; and so on. The plurality of preset sequences can include one preset sequence for each type of obstruction. The pairings of types of obstructions and preset sequences can be stored in a lookup table or the like, and the computer 44 can use the lookup table to select the preset sequence in response to identifying the type of obstruction. Each preset sequence for a type of obstruction can be created by experimentally testing the effectiveness of removing the corresponding type of obstruction from the sensor window 36.

Next, in a block 725, the computer 44 operates the pump 38, the first valve 42, the second valve 68 if present, and the pressure source 56 according to the selected preset sequence. FIG. 8A shows an example first preset sequence, FIG. 8B shows an example second preset sequence, and FIG. 8C shows an example third preset sequence. The computer 44 can store additional preset sequences beyond three. All the preset sequences include continuously activating the pump 38 for a first time period and continuously activating the pressure source 56 for the first time period. For example, the pump 38 can be inactive by default, be activated at the beginning of the first time period, remain active for all of the first time period, and be deactivated at the end of the first time period, as shown in FIGS. 8A-C. The pressure source 56 can be active by default, be activated at some time before the first time period, remain active for all of the first time period, and remain active after the end of the first time period. If the sensor system 32 includes the second valve 68, as in the second example of FIG. 3 and the fourth example of FIG. 5, then all the preset sequences include opening the second valve 68 when the first valve 42 is closed, and closing the second valve 68 when the first valve 42 is open.

The first preset sequence includes continuously activating the pump 38 for a first time period, i.e., activating the pump 38 without deactivating for the first time period. As shown in FIG. 8A, the first time period runs from T₀ to T₃. The first preset sequence includes opening and then closing the first valve 42 at least twice during the first time period. As shown in FIG. 8A, the first valve 42 opens at T₀, closes at T₁, opens at T₂, and closes at T₃. For example, T₀ could be zero milliseconds, T₁ could be 200 milliseconds, T₂ could be 300 milliseconds, and T₃ could be 500 milliseconds. The first valve 42 is closed by default, i.e., closed when not executing one of the preset sequences. If the sensor system 32 includes the second valve 68, as in the second example of FIG. 3 and the fourth example of FIG. 5, then the first preset sequence includes opening the second valve 68 when the first valve 42 is closed, and closing the second valve 68 when the first valve 42 is open. The second valve 68 is open by default. As shown in FIG. 8A, the second valve 68 closes at T₀, opens at T₁, closes at T₂, and opens at T₃. The first preset sequence includes continuously activating the pressure source 56 for the first time period; for example, as shown in FIG. 8A, the pressure source 56 is activated by default and is not deactivated during the first time period.

The first preset sequence can correspond to mud/dirt being the type of obstruction. By permitting time for the fluid to soak into the mud/dirt from T₁ to T₂, the sensor system 32 can remove the mud/dirt approximately as effectively while using less washer fluid than spraying fluid continuously from T₀ to T₃. Activating the pump 38 continuously from T₀ to T₃ can increase the lifespan of the pump 38 by subjecting the pump 38 to fewer duty cycles.

The second preset sequence includes continuously activating the pump 38 for a first time period, i.e., activating the pump 38 without deactivating for the first time period. As shown in FIG. 8B, the first time period runs from T₀ to T₂. The second preset sequence includes opening and then closing the first valve 42 once during the first time period. As shown in FIG. 8B, the first valve 42 opens at T₀ and closes at T₁. For example, T₀ could be zero milliseconds, T₁ could be 100 milliseconds, and T₂ could be 500 milliseconds. The first valve 42 is closed by default, i.e., closed when not executing one of the preset sequences. If the sensor system 32 includes the second valve 68, as in the second example of FIG. 3 and the fourth example of FIG. 5, then the second preset sequence includes opening the second valve 68 when the first valve 42 is closed, and closing the second valve 68 when the first valve 42 is open. The second valve 68 is open by default. As shown in FIG. 8B, the second valve 68 closes at T₀ and opens at T₁. The second preset sequence includes continuously activating the pressure source 56 for the first time period; for example, as shown in FIG. 8B, the pressure source 56 is activated by default and is not deactivated during the first time period.

The second preset sequence can correspond to dust being the type of obstruction. The dust can be removed by spraying fluid for a short duration, compared to the first preset sequence. Having different preset sequences available means that a more resource-efficient preset sequence can be used for easier-to-remove types of obstructions and a more resource-intensive preset sequence can be used for difficult-to-remove types of obstructions.

The third preset sequence includes continuously activating the pump 38 for a first time period, i.e., activating the pump 38 without deactivating for the first time period. As shown in FIG. 8C, the first time period runs from T₀ to T₃. The third preset sequence includes opening and then closing the first valve 42 at least twice during the first time period, but using at least one different time for opening or closing the first valve 42 than the first preset sequence. As shown in FIG. 8C, the first valve 42 opens at T₀, closes at T₁, opens at T₂, and closes at T₃. For example, To could be zero milliseconds, T₁ could be 100 milliseconds, T₂ could be 300 milliseconds, and T₃ could be 500 milliseconds. The first valve 42 is closed by default, i.e., closed when not executing one of the preset sequences. If the sensor system 32 includes the second valve 68, as in the second example of FIG. 3 and the fourth example of FIG. 5, then the third preset sequence includes opening the second valve 68 when the first valve 42 is closed, and closing the second valve 68 when the first valve 42 is open. The second valve 68 is open by default. As shown in FIG. 8C, the second valve 68 closes at T₀, opens at T₁, closes at T₂, and opens at T₃. The third preset sequence includes continuously activating the pressure source 56 for the first time period; for example, as shown in FIG. 8C, the pressure source 56 is activated by default and is not deactivated during the first time period. The third preset sequence can correspond to crushed insect being the type of obstruction.

Next, in a decision block 730, the computer 44 determines whether the vehicle 30 is still running. If the vehicle 30 has been turned off, the process 700 ends. If the vehicle 30 is still on, the process 700 returns to the block 705 to continue monitoring data from the sensor 34.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first,” “second,” “third,” and “fourth” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A sensor system comprising:
a sensor including a sensor window;
a pump;
a liquid nozzle aimed at the sensor window;
a valve positioned and operable to control fluid flow from the pump to the liquid nozzle; and
a computer communicatively coupled to the valve;
wherein the computer is programmed to:
in response to detecting an obstruction on the sensor window, continuously activate the pump for a first time period; and
during the first time period, operate the valve according to a preset sequence; and
the preset sequence includes opening and then closing the valve at least twice during the first time period.

2. The sensor system of claim 1, wherein
the sensor is communicatively coupled to the computer;
the preset sequence is a first preset sequence; and
the computer is further programmed to:
identify a type of the obstruction on the sensor window based on data received from the sensor;
select the first preset sequence from a plurality of preset sequences in response to identifying the type of the obstruction as a first type; and
during the first time period, operate the valve according to the selected preset sequence.

3. The sensor system of claim 2, wherein the plurality of preset sequences includes a second preset sequence, and the computer is further programmed to select the second preset sequence in response to identifying the type of the obstruction as a second type.

4. The sensor system of claim 3, wherein the second preset sequence includes opening and then closing the valve once during the first time period.

5. The sensor system of claim 1, further comprising:
an air nozzle aimed at the sensor window; and
a pressure source operable to supply gas to the air nozzle and communicatively coupled to the computer;
wherein the computer is further programmed to continuously activate the pressure source for the first time period.

6. The sensor system of claim 1, wherein the valve is a solenoid valve.

7. The sensor system of claim 1, wherein the valve is a first valve, the sensor system further comprising a reservoir and a second valve, wherein the pump is positioned to pump fluid from the reservoir to the first valve, and the second valve is positioned and operable to control fluid flow from the first valve to the reservoir.

8. The sensor system of claim 7, wherein the second valve is communicatively coupled to the computer, and the computer is further programmed to open the second valve when the first valve is closed and to close the second valve when the first valve is open.

9. The sensor system of claim 1, further comprising a shock-absorbing unit fluidly coupled to the valve and to the liquid nozzle, wherein the shock-absorbing unit includes a fluid chamber having a variable internal volume and a spring biasing the fluid chamber to a first internal volume.

10. The sensor system of claim 1, wherein the valve is a first valve; the sensor system further comprising a reservoir, a junction, and a second valve; wherein the pump is positioned to pump fluid from the reservoir to the junction, the junction splits fluid from the reservoir between the first valve and the second valve, and the second valve is positioned and operable to control fluid flow from the junction to the reservoir.

11. The sensor system of claim 10, further comprising a casing containing the junction, the first valve, and the second valve, wherein the casing is spaced from the pump and from the liquid nozzle.

12. The sensor system of claim 10, wherein the second valve is communicatively coupled to the computer, and the computer is further programmed to open the second valve when the first valve is closed and to close the second valve when the first valve is open.

13. A computer comprising a processor and a memory storing instructions executable by the processor to:
in response to detecting an obstruction on a sensor window of a sensor, continuously activate a pump for a first time period; and
during the first time period, operate a valve according to a preset sequence, the valve positioned and operable to control fluid flow from the pump to a liquid nozzle;
wherein the preset sequence includes opening and then closing the valve at least twice during the first time period.

14. The computer of claim 13, wherein the preset sequence is a first preset sequence, and the instructions further include to identify a type of the obstruction on the sensor window of the sensor based on data received from the sensor, select the first preset sequence from a plurality of preset sequences in response to identifying the type of the obstruction as a first type, and during the first time period, operate the valve according to the selected preset sequence.

15. The computer of claim 14, wherein the plurality of preset sequences includes a second preset sequence, and the instructions further include to select the second preset sequence in response to identifying the type of the obstruction as a second type.

16. The computer of claim 15, wherein the second preset sequence includes opening and then closing the valve once during the first time period.

17. The computer of claim 13, wherein the instructions further include to continuously activate a pressure source supplying an air nozzle for the first time period.

18. The computer of claim 13, wherein the valve is a first valve, and the instructions further include to open a second valve when the first valve is closed and to close the second valve when the first valve is open.

19. A method comprising:
in response to detecting an obstruction on the sensor window, continuously activating a pump for a first time period; and
during the first time period, operating a valve according to a preset sequence, the valve positioned and operable to control fluid flow from the pump to a liquid nozzle;
wherein the preset sequence includes opening and then closing the valve at least twice during the first time period.
